(19) United States
(12) Patent Application Publication
(10) Pub. No.: US 2015/0283935 A1
(43) Pub. Date: Oct. 8, 2015

(54) Organizing Apparatus for Utility Straps

(71) Applicant: Nicholas Carmen Marinelli, Erie, PA (US)

(72) Inventor: Nicholas Carmen Marinelli, Erie, PA (US)

(21) Appl. No.: 14/247,621

(22) Filed: Apr. 8, 2014

(51) Int. Cl. B60P 7/08; F16M 13/02

(52) U.S. Cl. CPC B60P 7/0846; B60P 7/0869; F16M 13/022

(57) ABSTRACT

What is presented is an organizing apparatus for a plurality of utility straps. The organizing apparatus comprises a tube comprising a plurality of openings. The plurality of openings are configured to allow releasable securing of the plurality of utility straps to the tube. The shape of each of the plurality of openings can be ovular, trianglular, circular, octogonal, or square. The cross section of the tube can be ovular, trianglular, circular, octogonal, or square. The tube can be constructed from plastic, metal, vinyl, rubber, wood, glass, fiber glass, or a paper-based material.

### BACKGROUND

For anyone who uses utility straps, including laborers in both the construction and mechanical industries, storage and organizing of utility straps has proven to be a difficult and strenuous chore. In typical storage situations, after being strewn together, the utility straps tend to tangle, intertwine and create knots with each other, which potentially causes damage and stress while attempting to reorganize the utility straps. Untangling the utility straps can also be very difficult and time consuming, which in certain circumstances can even cause adverse business consequences.

Over the years, various previously-created devices have attempted to solve the problems associated with storage and organizing utility straps. None of which have had the ability to adjust to the specific length of the utility straps being accommodated nor the ability to releasably secure more than a single kind of utility strap, let alone various kinds of utility straps during a single use. None of these devices can be either stationary or portable, depending on the needs of the user. Moreover, many of these devices consume considerable amounts of space and cannot be used in a wide variety of locations or situations. Thus, there has been a long-felt need to not only store and organize utility straps, but avoid the issues not overcome by the previously-created devices. What is presented is an organizing apparatus that can store and organize utility straps as well as overcome unsolved problems faced by the dissimilar previously-created devices.

### SUMMARY

What is presented is an organizing apparatus for a plurality of utility straps. The organizing apparatus comprises a tube, which comprises a plurality of openings. The plurality of openings are configured to allow the releasable securing of the plurality of utility straps to the tube. The shape of each of the plurality of openings can be ovular, trianglular, circular, octogonal, or square. The cross section of the tube can also be ovular, trianglular, circular, octogonal, or square. The tube can be constructed from plastic, metal, vinyl, rubber, wood, glass, fiber glass, or a paper-based material.

The tube can be configured to mount to a bracket. The bracket can be configured to allow the organizing apparatus to mount to a surface. In certain embodiments, the tube is configured to rotate when it is mounted to the bracket and the bracket comprises a hitch pin configured to stop said tube from rotating, when needed. In other embodiments, a cap is located at each end of the tube and each cap is configured to mount the tube to the bracket. Each cap is configured to allow the tube to rotate when mounted to the bracket.

The tube can comprise a plurality of tube lengths. In certain embodiments, the organizing apparatus comprises a coupling configured to connect two of these tube lengths. In other embodiments, each tube length comprises a male end and a female end. The male end of one tube length is configured to connect with the female end of another tube length.

A handle can be releasably secured to the organizing apparatus. A peg clip can also be releasably secured to the organizing apparatus. A crank can also be releasably secured to the organizing apparatus. The organizing apparatus can also be mounted to a bracket hook.

What is also presented is an organizing apparatus for a plurality of utility straps that comprises a tube, which comprises a plurality of openings, and a plurality of tube lengths, each of which have a male end and a female end. The tube is configured to mount to a bracket. The shape of each of the openings is ovular. The cross section of the tube is square. The plurality of openings are configured to allow releasable securing of the plurality of utility straps to the tube. The male end of one tube length is configured to connect with the female end of another tube length.

The cross section of the tube can be ovular, trianglular, circular, octogonal, or square. The tube can be constructed from plastic, metal, vinyl, rubber, wood, glass, fiber glass, or a paper-based material. The bracket can be configured to allow the organizing apparatus to mount to a surface. A handle can be releasably secured to the organizing apparatus. A peg clip can also be releasably secured to the organizing apparatus. A crank can also be releasably secured to the organizing apparatus. The organizing apparatus can be mounted to a bracket hook. In certain embodiments, the tube is configured to rotate when mounted to the bracket and the bracket comprises a hitch pin that is configured to stop said tube from rotating, when needed.

What is also presented is an organizing apparatus for a plurality of utility straps that comprises a tube comprising a plurality of openings and a cap located at each end. The shape of each of the openings is ovular. The cross section of the tube is square. The plurality of openings are configured to allow releasable securing of the plurality of utility straps to the tube. Each cap is configured to mount the tube to the bracket and configured to allow the tube to rotate when mounted to the bracket.

The cross section of the tube can be ovular, trianglular, circular, octogonal, or square. The tube can be constructed from plastic, metal, vinyl, rubber, wood, glass, fiber glass, or a paper-based material. The bracket can be configured to allow the organizing apparatus to mount to a surface. The tube can comprise a plurality of tube lengths. The organizing apparatus can comprise a coupling configured to connect two of these tube lengths. A handle can be releasably secured to the organizing apparatus. A peg clip can also be releasably secured to the organizing apparatus. A crank can also be releasably secured to the organizing apparatus. The organizing apparatus can be mounted to a bracket hook.

Those skilled in the art will realize that this invention is capable of embodiments that are different from those shown and that details of the apparatus and methods can be changed in various manners without departing from the scope of this invention. Accordingly, the drawings and descriptions are to be regarded as including such equivalent embodiments as do not depart from the spirit and scope of this invention.

### BRIEF DESCRIPTION OF DRAWINGS

For a more complete understanding and appreciation of this invention, and its many advantages, reference will be made to the following detailed description taken in conjunction with the accompanying drawings.

FIG. 1 shows a perspective view of an embodiment of the organizing apparatus onto which a plurality of releasably securable utility straps are secured;

FIG. 2 shows the perspective view of the organizing apparatus of FIG. 1 without the plurality of releasably securable utility straps secured onto it;

FIG. 2A shows the cross section of the organizing apparatus of FIG. 2, depicted by the figure lines 2A-2A;

FIG. 3 shows an exploded side view of the organizing apparatus of FIG. 1, depicting how it is assembled and mounted to a surface;

FIG. 4 shows a cut away side view of the organizing apparatus of FIG. 2;

FIG. 5 shows a perspective view of the tube length of the organizing apparatus of FIG. 2;

FIG. 6 shows a different perspective view of the tube length of the organizing apparatus of FIG. 2;

FIG. 7 shows a perspective view of the bracket of the organizing apparatus of FIG. 2;

FIG. 8 shows a different perspective view of the bracket of the organizing apparatus of FIG. 2;

FIG. 9 shows a perspective view of the organizing apparatus of FIG. 2, with a releasably secured handle;

FIG. 10 shows a perspective view of the organizing apparatus of FIG. 2, with another embodiment of the releasably secured handle;

FIG. 11 shows a perspective view of the organizing apparatus of FIG. 2, with an extension cord wrapped around a plurality of releasably secured peg clips;

FIG. 12 shows a perspective view of the organizing apparatus of FIG. 2, mounted to a bracket hook;

FIG. 13 shows a perspective view of another embodiment of the organizing apparatus; FIG. 13A shows the cross section of the organizing apparatus of FIG. 13, depicted by the figure lines 13A-13A;

FIG. 14 shows a perspective view of another embodiment of the organizing apparatus;

FIG. 14A shows the cross section of the organizing apparatus of FIG. 14, depicted by the figure lines 14A-14A;

FIG. 15 shows a perspective view of another embodiment of the organizing apparatus;

FIG. 15A shows the cross section of the organizing apparatus of FIG. 15, depicted by the figure lines 15A-15A;

FIG. 16 shows a perspective view of another embodiment of the organizing apparatus;

FIG. 16A shows the cross section of the organizing apparatus of FIG. 16, depicted by the figure lines 16A-16A;

FIG. 17 shows a perspective view of another embodiment of the organizing apparatus;

FIG. 17A shows the cross section of the organizing apparatus of FIG. 17, depicted by the figure lines 17A-17A;

FIG. 18 shows an exploded side view of the organizing apparatus of FIG. 17, mounted to a surface;

FIG. 19 shows a front view of a bracket of the organizing apparatus of FIG. 17;

FIG. 20 shows a front view of another bracket of the organizing apparatus of FIG. 17;

FIG. 21 shows a perspective view of another embodiment of the organizing apparatus;

FIG. 21A shows the cross section of the organizing apparatus of FIG. 21, depicted by the figure lines 21A-21A;

FIG. 22 shows a perspective view of another embodiment of the organizing apparatus;

FIG. 22A shows the cross section of the organizing apparatus of FIG. 22, depicted by the figure lines 22A-22A;

FIG. 23 shows a perspective view of another embodiment of the organizing apparatus;

FIG. 23A shows the cross section of the organizing apparatus of FIG. 23, depicted by the figure lines 23A-23A;

FIG. 24 shows a perspective view of another embodiment of the organizing apparatus;

FIG. 24A shows the cross section of the organizing apparatus of FIG. 24, depicted by the figure lines 24A-24A;

FIG. 25 shows a side view of the organizing apparatus of FIG. 2 comprising another embodiment of the plurality of openings;

FIG. 26 shows a side view of the organizing apparatus of FIG. 2 comprising another embodiment of the plurality of openings;

FIG. 27 shows a side view of the organizing apparatus of FIG. 2 comprising another embodiment of the plurality of openings;

FIG. 28 shows a side view of the organizing apparatus of FIG. 2 comprising another embodiment of the plurality of openings;

FIG. 29 shows a side view of the organizing apparatus of FIG. 17 comprising another embodiment of the plurality of openings;

FIG. 30 shows a side view of the organizing apparatus of FIG. 17 comprising another embodiment of the plurality of openings;

FIG. 31 shows a side view of the organizing apparatus of FIG. 17 comprising another embodiment of the plurality of openings; and

FIG. 32 shows a side view of the organizing apparatus of FIG. 17 comprising another embodiment of the plurality of openings.

### DETAILED DESCRIPTION

Referring to the drawings, some of the reference numerals are used to designate the same or corresponding parts through several of the embodiments and figures shown and described. Corresponding parts are denoted in different embodiments with the addition of lowercase letters. Variations of corresponding parts in form or function that are depicted in the figures are described. It will be understood that variations in the embodiments can generally be interchanged without deviating from the invention.

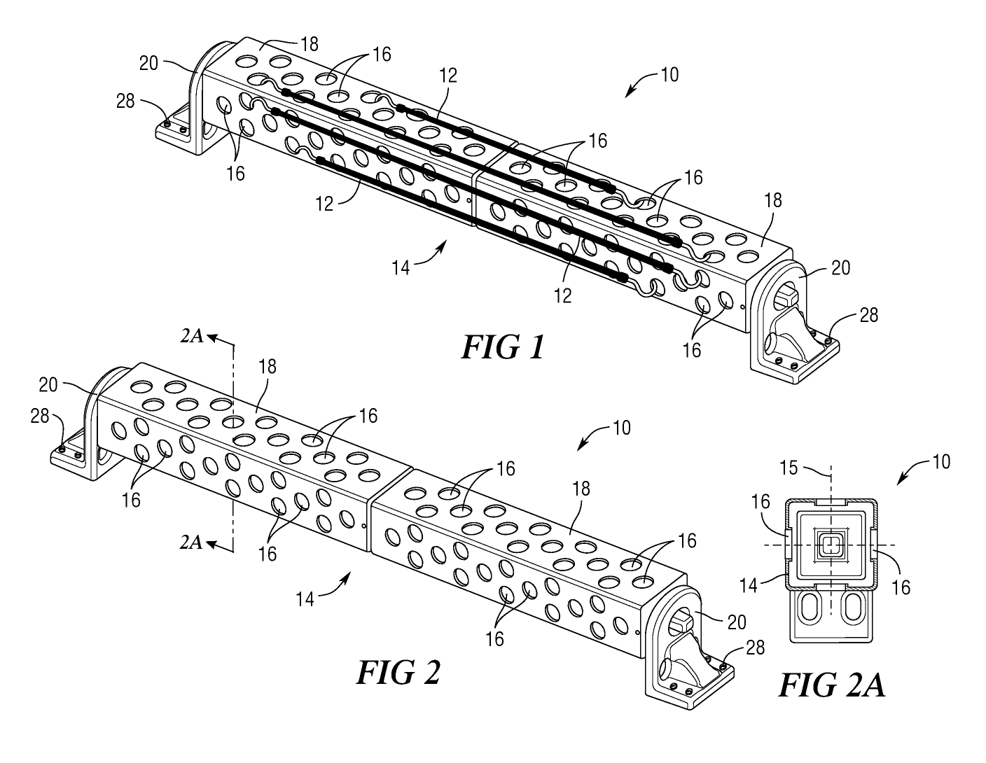

As shown in FIGS. 1 and 2, an organizing apparatus 10 is used to organize utility straps 12. The organizing apparatus 10 comprises a tube 14 that comprises a plurality of circular shaped openings 16. Each of these openings is configured to allow the utility straps 12 to releasably secure to the tube 14. One end of one of the utility straps 12 hooks into one of the openings 16 located near one end of the tube 14 and the other end of that utility strap 12 hooks into a corresponding opening 16 located near the opposite end of the tube 14. When releasably secured in a proper fashion, the utility strap 12 should be tight and held closely along the length of the tube 16. As shown, the openings 16 are distributed along the tube 16 in an orientation that allows multiple styles of utility straps to releasably secure to the tube 16 (and not limited to the style shown in the figures). These styles of utility straps include, but are not limited to, ratchet straps, elastic straps, and bungee cords. The orientation of the openings 16 also allows for utility straps 12 of varying lengths to be releasably secured to the tube 16. It should be understood that the openings 16 may be distributed in other orientations not shown in the figures and that one or more of the utility straps 16 can be releasably secured to the tube 14 in a manner not shown in the figures. As shown in FIG. 2A, the cross section 15 of the tube 14 is square and the tube 14 is constructed from metal. It should be understood that the tube 14 may also be constructed from, but is not limited to, plastic, vinyl, rubber, wood, glass, fiber glass, or a paper-based material.

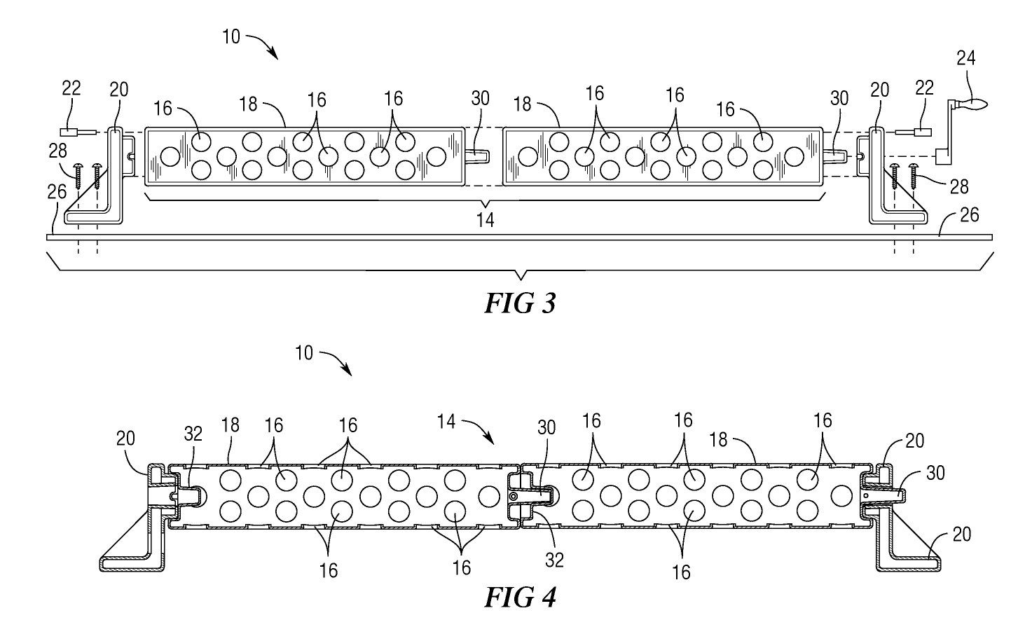

As shown in FIG. 3, the tube 14 is comprised of a plurality of tube lengths 18 that, when assembled, are configured to mount to a bracket 20 at each end of the assembled tube 14. When properly mounted, the tube 14 has the ability to rotate around its axis. This ability allows the organizing apparatus 10 to releasably secure a number of utility straps 12 while using a relatively limited amount of space. The ability to rotate the tube 14 also makes it easier to organize a plurality of utility straps 12 in a number of ways. In certain embodiments, one or both brackets 20 comprise a hitch pin 22 that extends into an end of the tube 14 via a hole or other similar device (not shown) through the bracket 20. The hitch pin 22 can stop the tube 14 from being able to rotate axially, which may be useful in certain situations. A crank 24 can be releasably secured or permanently secured to the male end 30 (discussed below) of the tube 14. The crank 24 makes axial rotation of the tube 14 easier, when needed.

The brackets 20 also allow the organizing apparatus 10 to mount to a surface 26 through the use of joining mechanisms 28. Shims (not shown) can be implemented to assist in leveling the organizing apparatus 10 with the surface 26. As shown, the organizing apparatus 10 is mounted to the surface 26 in an upright-vertical orientation. However, it should be understood that the organizing apparatus 10 may be mounted to the surface in other alternative orientations. For example, the organizing apparatus 10 may be mounted to a wall or ceiling of a room or some kind of vehicle. The surface 26 can found be in or on a variety of locations, such as, but not limited to, a truck bed, automobile, boat, trailer, semi-tractor trailer, building, garage, basement, workbench, or factory, scrap yard, or workshop. The plurality of joining mechanisms 28 is shown as screws, but one having ordinary skill in the art would understand that the joining mechanisms may be, but not limited to, bolts, adhesives, nails, tacks, hook and loop fasteners, and staples.

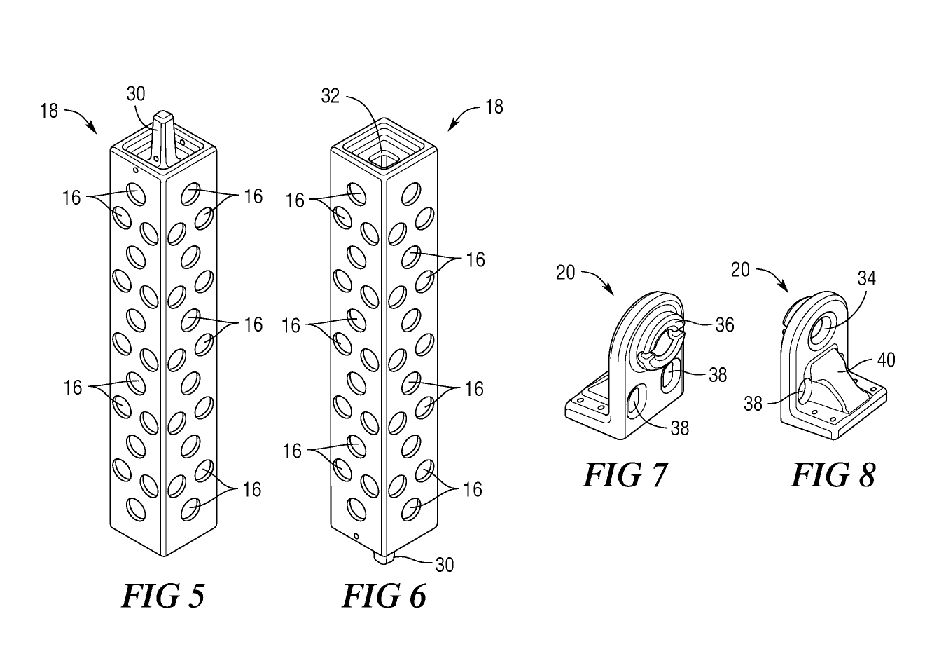

As shown in FIGS. 4-6 and mentioned above, the tube 14 is comprised of a plurality of tube lengths 18. In this embodiment, each tube length 18 is stacked with at least one other tube length 18 to assemble the tube 14. This stacking ability allows the tube 14 to be created for the specific length of the utility straps being accommodated, especially when unusually elongated utility straps are being accommodated. It should be understood that, as shown, the tube 14 comprises two tube lengths 18, but the tube 14 may comprise an unlimited number of additional tube lengths 18. Each tube length 18 may be identical and modular so that the tube lengths 18 can be arranged in any order.

Each tube length 18 comprises a male end 30 and a female end 32. The male end 30 of one tube length 18 is configured to connect with the female end 32 of another tube length 32. The male end 30 extends into and interlocks with opening created by the female end 32. Both the male end 30 and the female end 32 have corresponding cross sections (not shown), which interlock and help keep the tube lengths 18 from unduly slipping, wobbling, or rotating with each other. When properly constructed, the tube 14 itself has an unused male end 30 at one end and an unused female end 32 at the opposite end that are not interlocked with any other tube length 18.

The brackets of this embodiment of the organizing apparatus are best shown by comparing FIGS. 4, 7 and 8. Each bracket 20 comprises a bracket port 34 and a bracket extension 36. The bracket 20 is configured to mount to either end of the tube 14 and two brackets 20 are needed to properly mount the tube 14. The unused male end 30 of the tube 14 interlocks into the bracket port 34 of one bracket 20. The bracket extension 36 of the other bracket 20 then interlocks into the unused female end 32 at the opposite end of the tube 14. It should be understood that other embodiments of the bracket 20 could be constructed as one uniform part that both ends of the tube 14 interlock with for proper mounting.

The bracket 20 also comprises a plurality of bracket openings 38. When the tube 14 is properly mounted, the bracket openings 38 can be used to releasably secure a utility strap next to and along each side of the tube 14. The bracket openings 38 also help to reduce the overall weight of each bracket 20. The backside of the bracket 20 has a slope 40 that reinforces the bracket 20 to prevent the bracket 20 from bending backward and causing the tube 14 to dismount during the operation of the organizing apparatus 10.

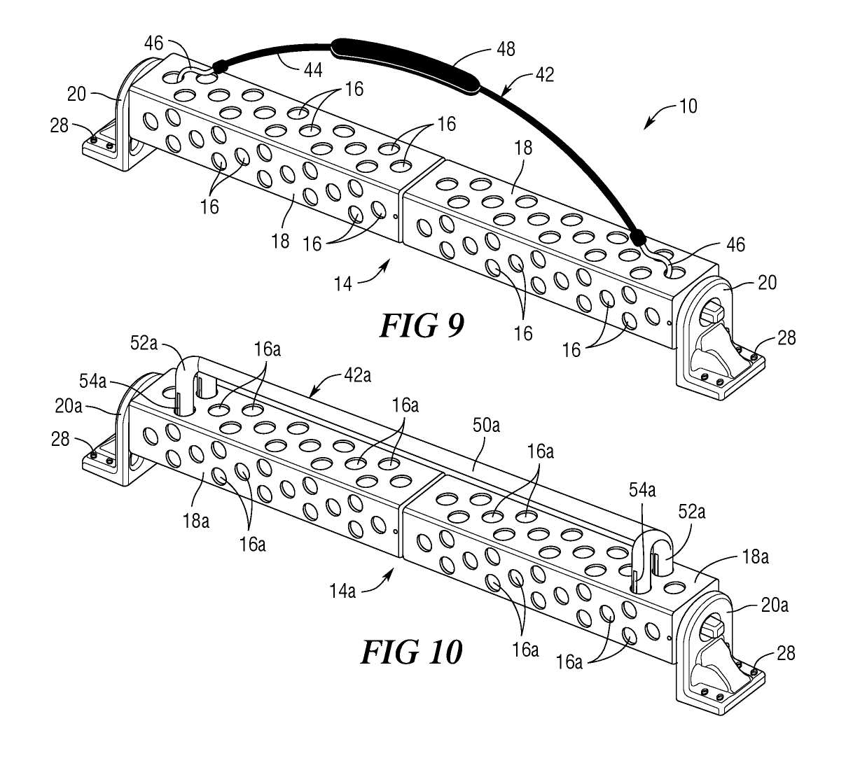

As shown in FIG. 9, a handle 42 can be releasably secured to the organizing apparatus 10 through the tube 14. The handle 42 facilitates the portability of the organizing apparatus 10 when not mounted to a surface. In this embodiment, the handle 42 comprises a handle strap 44, plurality of handle hooks 46, and a handle grip 48. To releasably secure the handle 42 to the organizing apparatus 10, one handle hook 46 is hooked into an opening 16 near one end of the tube 14 and another handle hook 46 is hooked into an opening 16 near the other end of the tube 14. A user (not shown) of the organizing apparatus 10 can simply take a hold of the handle 42 via the handle grip 48 and move the organizing apparatus 10 from one location to another. The handle strap 44 connects the entire handle 42 together and can be constructed from, but not limited to, rubber, leather, rope, plastic, metal, elastic. The handle strap 44 could also be a chain link or other acceptable strap-like device.

As shown in FIG. 10, another embodiment of the handle 42a can be releasably secured to the organizing apparatus 10a through the tube 14a. This embodiment of the handle 42a comprises a handle bar 50a and a plurality of handle inserts 52a. To releasably secure the handle 42a to the organizing apparatus 10a, each handle insert 52a is inserted into a respective opening 16a along the tube 14a. One set of handle inserts 52a should be inserted into openings 16a near one end of the tube 14a and another set of handle inserts 52a should be hooked into openings 16a near the other end of the tube 14a. Snaps (not shown) at the end of each handle insert 52a releasably secure the handle 42a in place and keep the handle inserts 52a from falling out of their respective openings 16a, which in turn keeps the entire handle 42a releasably secured to the organizing apparatus 10a. To release the handle 42a from being secured, the handle insert 52a can be pinched via an insert notch Ma centrally located through the middle of the handle insert 52a. When pinched, the circumference of the snaps becomes smaller than the circumference of the opening 16a and the handle insert 52a can easily slide out of the opening. The handle 42a can be constructed from, but is not limited to, plastic, metal, vinyl, rubber, wood, glass, fiber glass, or a paper-based material or any combination thereof.

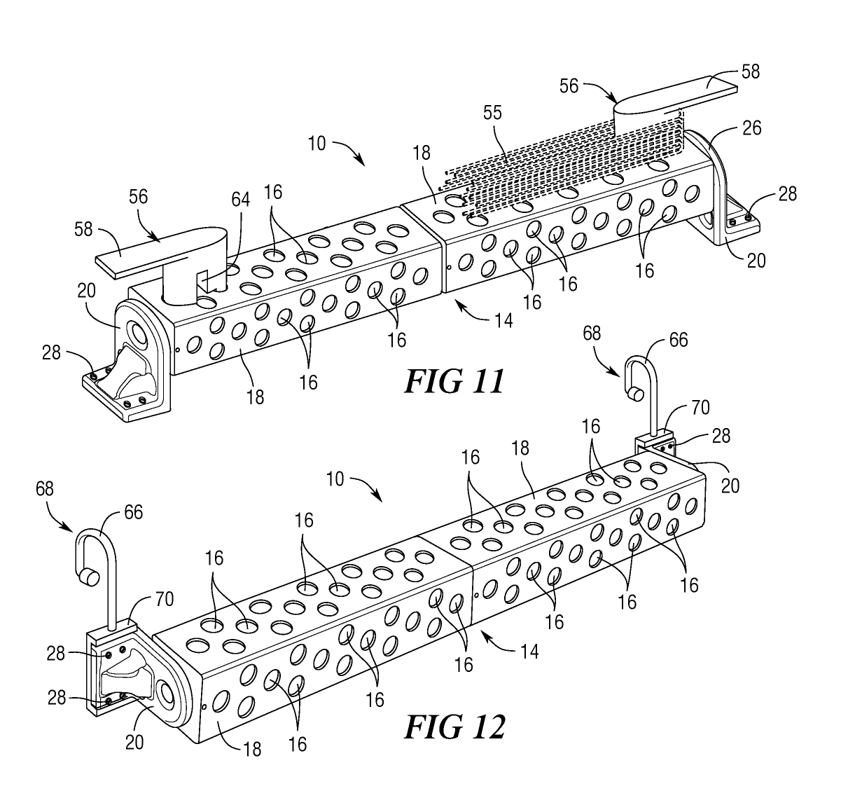

As shown in FIG. 11, an extension cord 55 can be wrapped around the organizing apparatus 10 through the implementation of a plurality of releasably securable peg clips 56. Each peg clip 56 comprises a peg flap 58, peg body 60 and peg insert 62. When properly wrapped, the extension cord 55 is kept in place by the peg flap 58 of each of the plurality of peg clips 56. The peg flaps 58 also ensure the extension cord 55 does not become unraveled and fall off the organizing apparatus 10, especially when the organizing apparatus 10 is moved from one location to another. It should be understood that other elongated string-like devices could be wrapped around the organizing apparatus 10, such as, but not limited to, wire, rope, Christmas lights, etc. This would also work for utility straps that are too long to fit on the organizing apparatus 10, not having the releasably securable plurality of peg clips 56 on it.

To releasably secure each peg clip 56 to the organizing apparatus 10, the peg insert 62 is inserted into two respective openings 16 along the tube 14. One peg clip 56 should be inserted into two openings 16 near one end of the tube 14 and another peg clip 56 should be inserted into two openings 16 near the other end of the tube 14. Peg snaps (not shown) at the end of the peg insert 62 releasably secure the peg clip 56 in place and keep the peg inserts 62 from falling out of their respective openings 16. To release the peg clip 56 from being secured, the peg insert 56 can be pinched via a peg notch 64 centrally located through the middle of the peg insert 56. When pinched, the respective peg snaps move away from the respective circumference of the opening 16 and the peg inserts 62 can easily slide out of their opening 16. Each peg clip 56 can be constructed from, but is not limited to, plastic, metal, vinyl, rubber, wood, glass, fiber glass, or a paper-based material or a combination thereof.

As shown in FIG. 12, the organizing apparatus 10 can be mounted to a bracket hook 66. The bracket hook 66 comprises a plurality of hangers 68 and mounting pads 70. The hangers 68 allow the organizing apparatus 10 to be temporarily hung over vertical structures, such as, but not limited to, doors and workstation partitions. To be properly mounted, each bracket 20 is mounted to the respective mounting pad 70 through the use of the joining mechanisms 28. As explained above, the joining mechanisms 28 are shown as screws, but one having ordinary skill in the art would understand that the joining mechanisms 28 may be, but are not limited to, bolts, adhesives, nails, tacks, hook and loop fasteners, and staples. Shims (not shown) may also be implemented to assist in leveling the organizing apparatus 10 with the bracket hook 66.

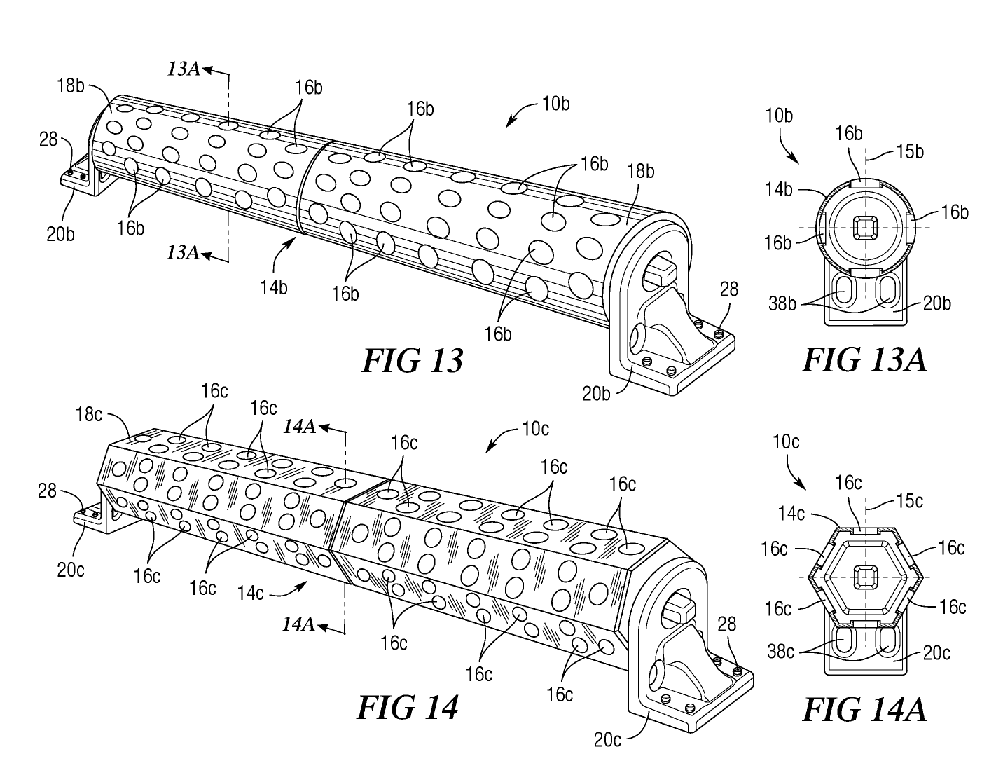

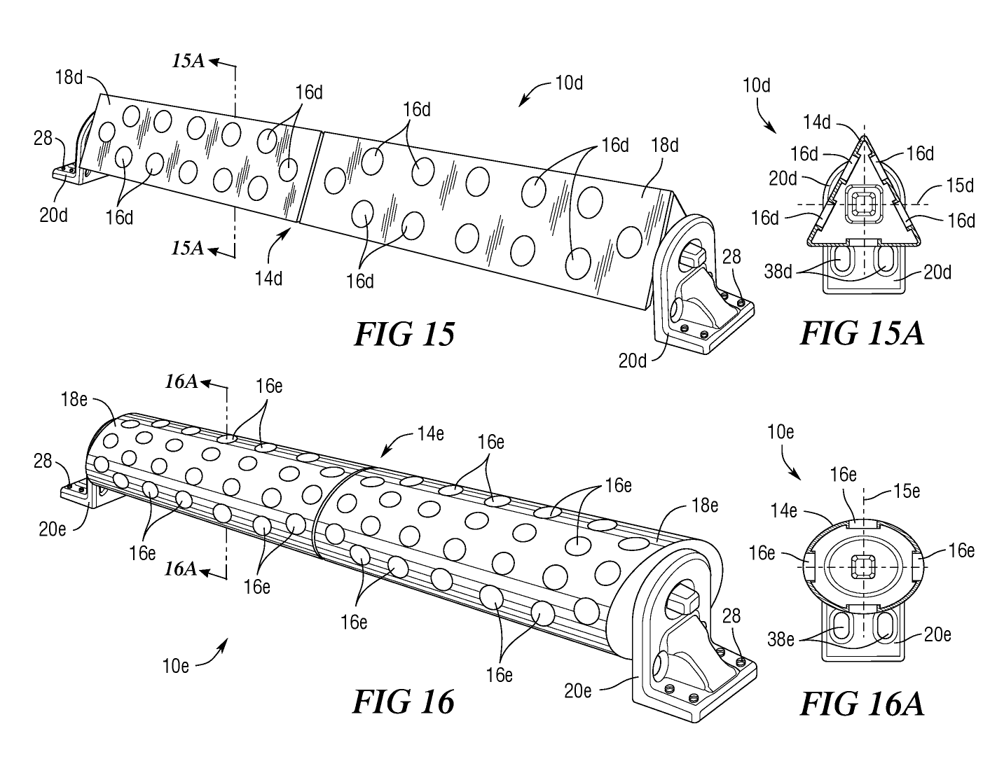

As shown in FIGS. 13 and 13A, the cross section 15b of the tube 14b can be circular. As shown in FIGS. 14 and 14A, the cross section 15c of the tube 14c can be octogonal. As shown in FIGS. 15 and 15A, the cross section 15d of the tube 14d can be trianglular. As shown in FIGS. 16 and 16A, the cross section 15e of the tube 14e can be ovular.

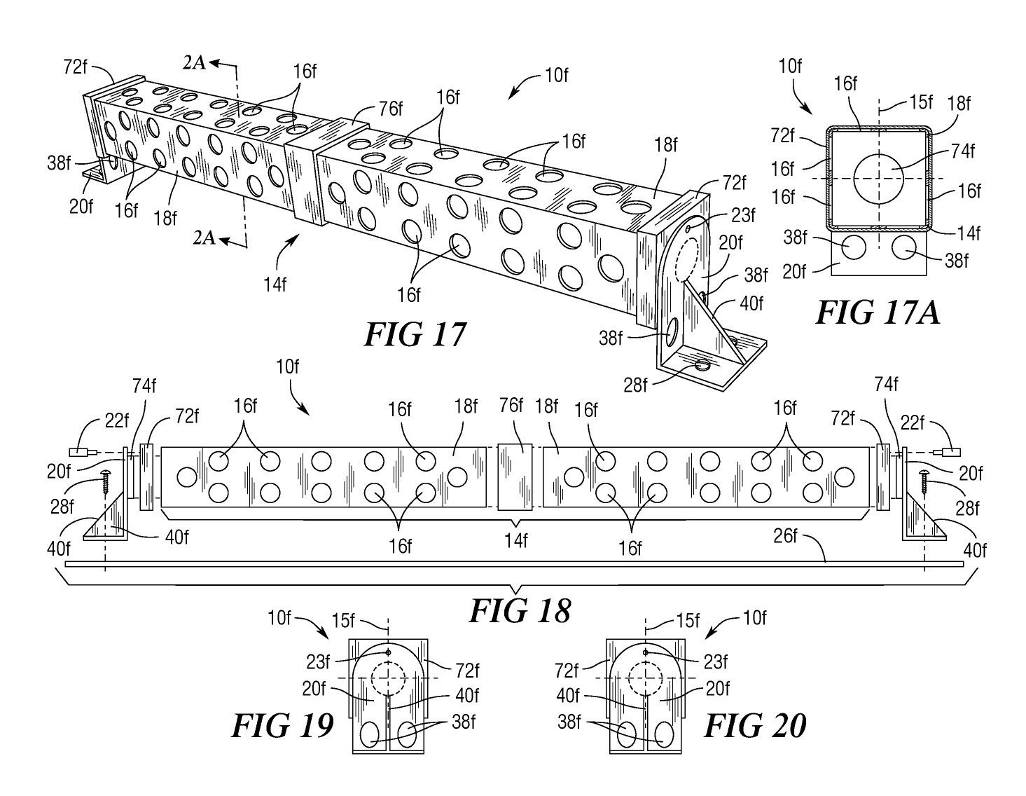

As shown in FIGS. 17, another embodiment of the organizing apparatus 10f can be used to organize utility straps 12f. The organizing apparatus 10f comprises a tube 14f that comprises a plurality of circular shaped openings 16f. The tube 14f is comprised of a plurality of tube lengths 18f that when combined are configured to mount to a bracket 20f at each end. A cap 72f is located at each end of the tube 14f. Each cap 72f is configured to mount the tube 14f to the brackets 20f. When mounted to the brackets 20f, the caps 72f are also configured to rotate the tube 14f around its axis. Each bracket 20f comprises a circular-shaped knob 74b that inserts into the corresponding cap opening (not shown) on the respective cap 72f, which gives the tube 14f the ability to rotate axially. As shown in FIG. 17A, the cross section 15f of the tube 14f is square and the tube 14f is constructed from metal. It should be understood that the tube 14f may also be constructed from, but is not limited to, plastic, vinyl, rubber, wood, glass, fiber glass, or a paper-based material or any combination thereof.

As best understood by referring to FIGS. 17 and 18, in certain embodiments, one or both brackets 20f comprise a hitch pin 22f that extends into an end of the tube 14f via a hole 23f. The hitch pin 22f can stop the tube 14f from being able to rotate axially, which may be useful in certain situations. The brackets 20f also allow the organizing apparatus 10f to mount to a surface 26f through the use of joining mechanisms 28f. As shown and discussed in more detail above, the organizing apparatus 10f is mounted to the surface 26f in an upright-vertical orientation but may be mounted to the surface in other alternative orientations. The plurality of joining mechanisms 28f is shown as screws, but one having ordinary skill in the art would understand that the joining mechanisms may be, but are not limited to, bolts, adhesives, nails, tacks, hook and loop fasteners, and staples. Shims (not shown) may also be implemented to assist in leveling the organizing apparatus 10f with the surface 26f.

As mentioned above, the tube 14f is comprised of a plurality of tube lengths 18f. In this embodiment, each tube length 18f is connected with at least one other tube length 18f through the implementation of a coupling 74f configured to connect two of the tube lengths 18f together. The coupling 74f also allows for the tube 14f to be created for the specific length of the utility straps being accommodated, especially when unusually elongated utility straps are being accommodated. It should be understood that as shown the tube 14f comprises two tube lengths 18f, but the tube 14f may comprise a number of additional tube lengths 18f and couplings 74f as needed.

As shown in FIGS. 19 and 20, each bracket 20f is configured to mount to either end of the tube 14f and two brackets 20f are needed to mount the tube 14f. It should be understood that other embodiments of the bracket 20f could be constructed as one uniform part that both ends of the tube 14f interlock with for proper mounting. The bracket 20f also comprises a plurality of bracket openings 38f. When the tube 14f is properly mounted, the bracket openings 38f can be used to releasably secure a utility strap next to and along each side of the tube 14f. The bracket openings 38f also help to reduce the overall weight of each bracket 20f. The backside of the bracket 20f has a slope 40f that enforces the bracket 20f from bending backwards and causing the tube 14f to dismount during the operation of the organizing apparatus 10f.

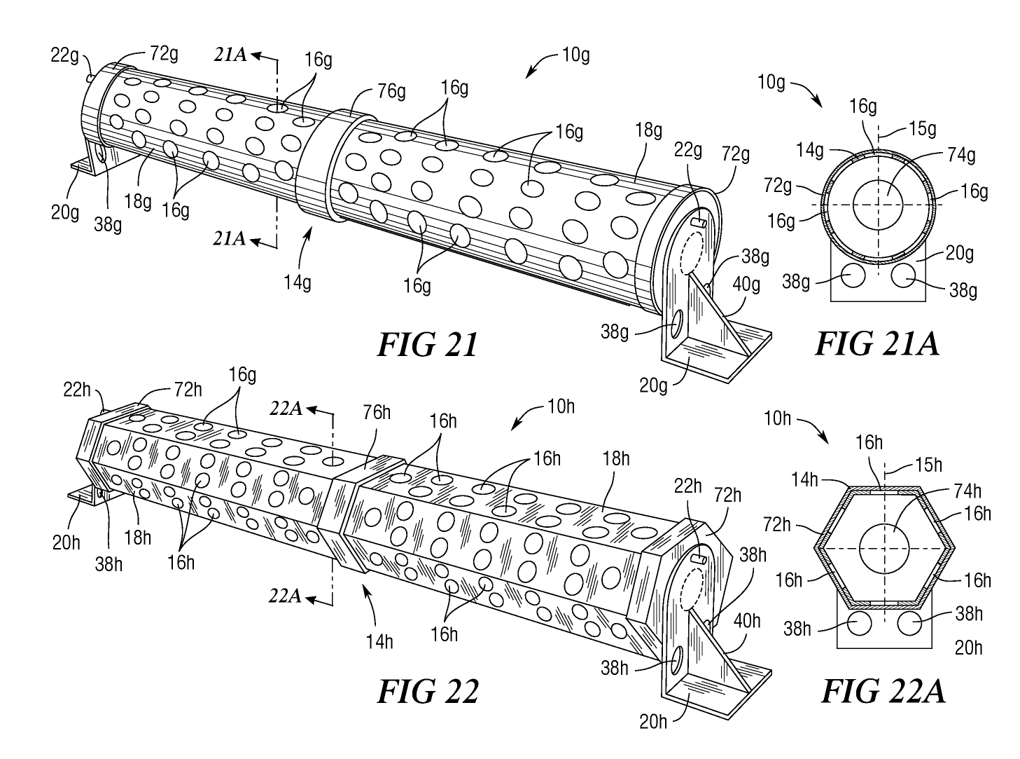

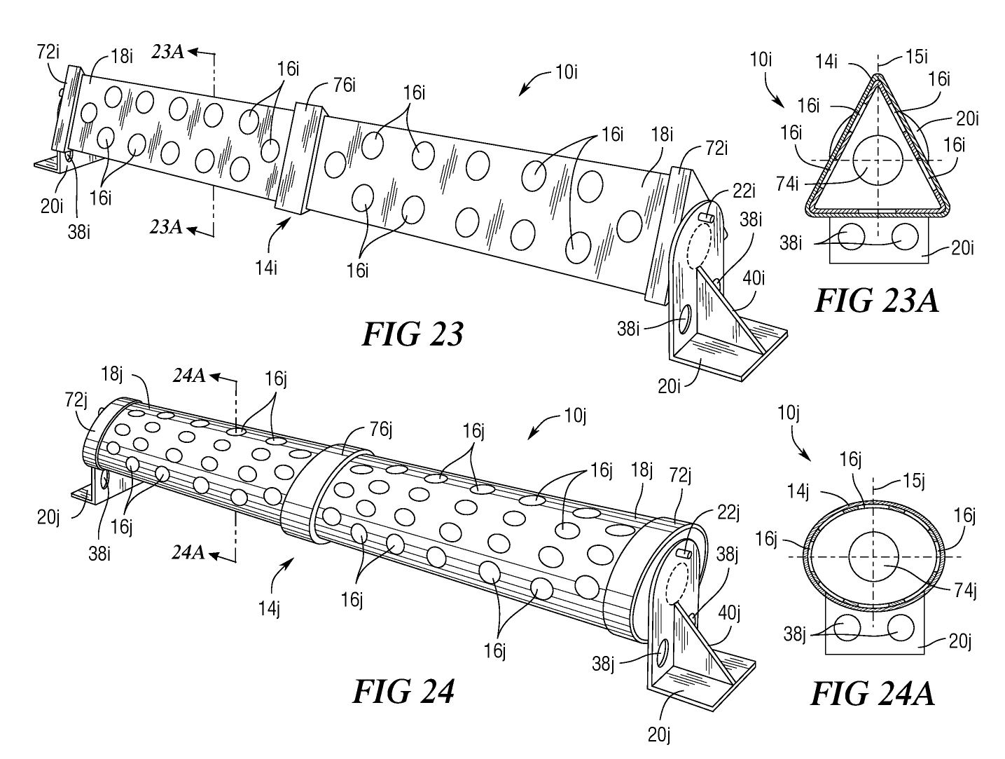

As shown in FIGS. 21 and 21A, the cross section 15g of the tube 14g of the embodiment of the organizing apparatus discussed in FIGS. 17 through 20 can be circular. As shown in FIGS. 22 and 22A, the cross section 15h of the tube 14h of the embodiment of the organizing apparatus discussed in FIGS. 17 through 20 can be octogonal. As shown in FIGS. 23 and 23A, the cross section 151 of the tube 141 of the embodiment of the organizing apparatus discussed in FIGS. 17 through 20 can be trianglular. As shown in FIGS. 24 and 24A, the cross section 15j of the embodiment of the organizing apparatus discussed in FIGS. 17 through 20 can be ovular.

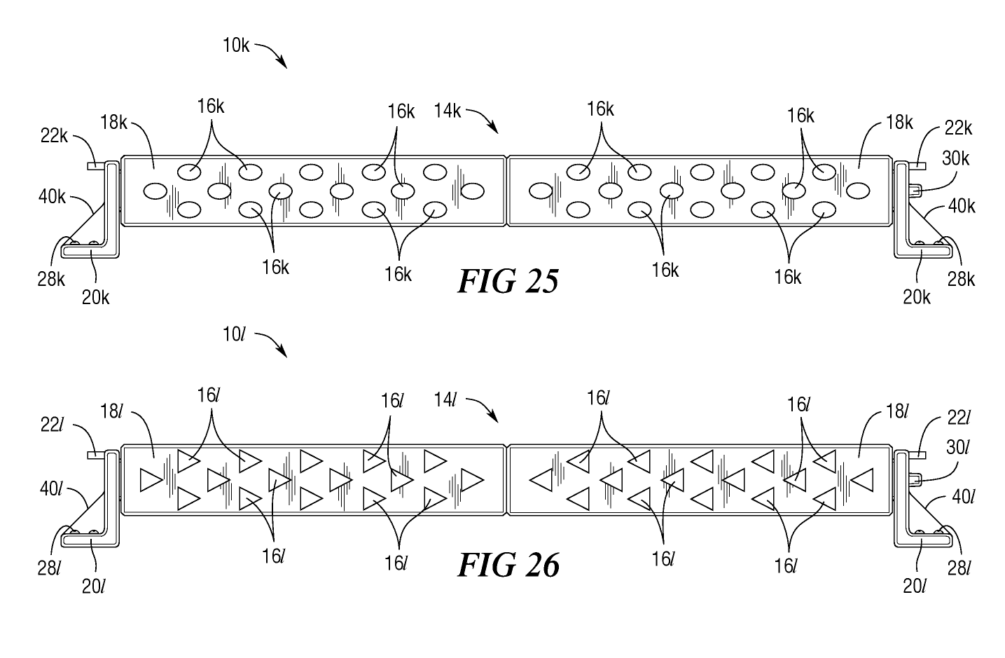

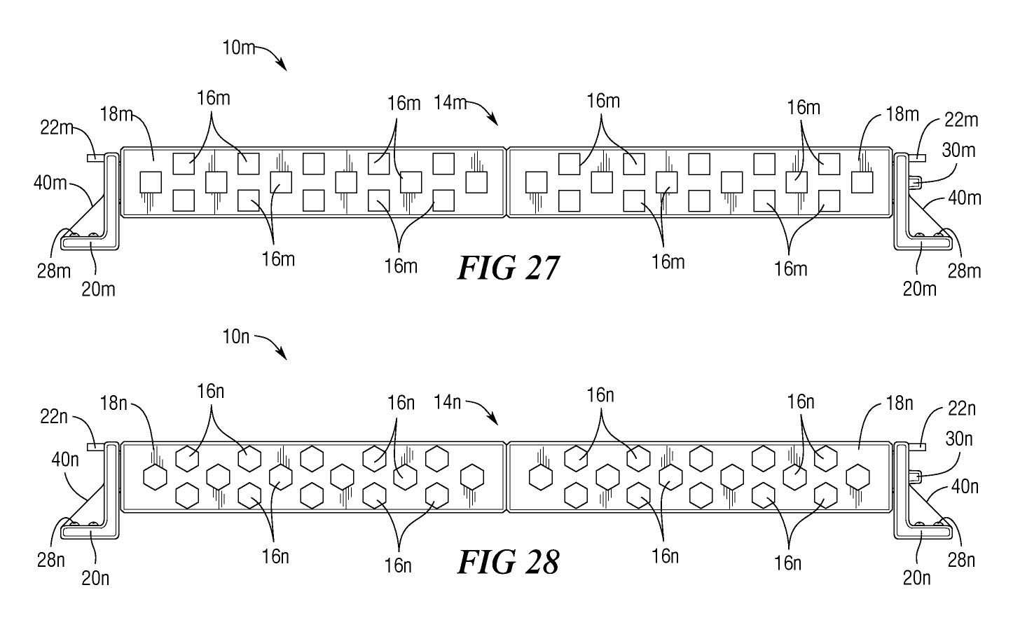

As shown in FIG. 25, the shape of each of the openings 16k of the organizing apparatus 10k are ovular. As shown in FIG. 26, the shape of each of the openings 161 of the organizing apparatus 101 are trianglular. As shown in FIG. 27, the shape of each of the openings 16m of the organizing apparatus 10m are square. As shown in FIG. 28, the shape of each of the openings 16n of the organizing apparatus 10n are octogonal.

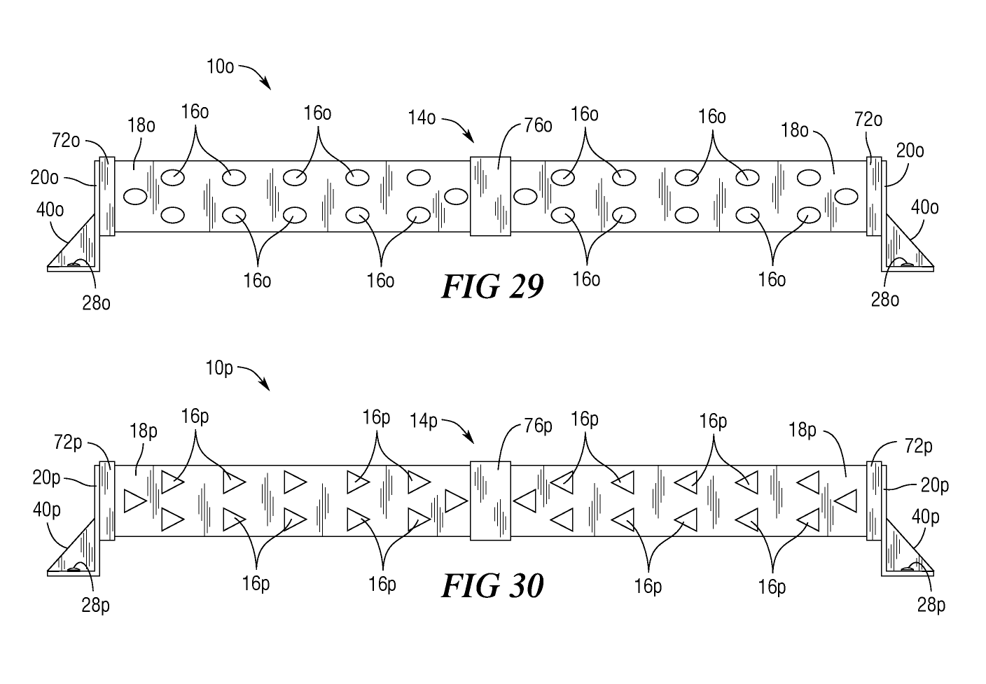

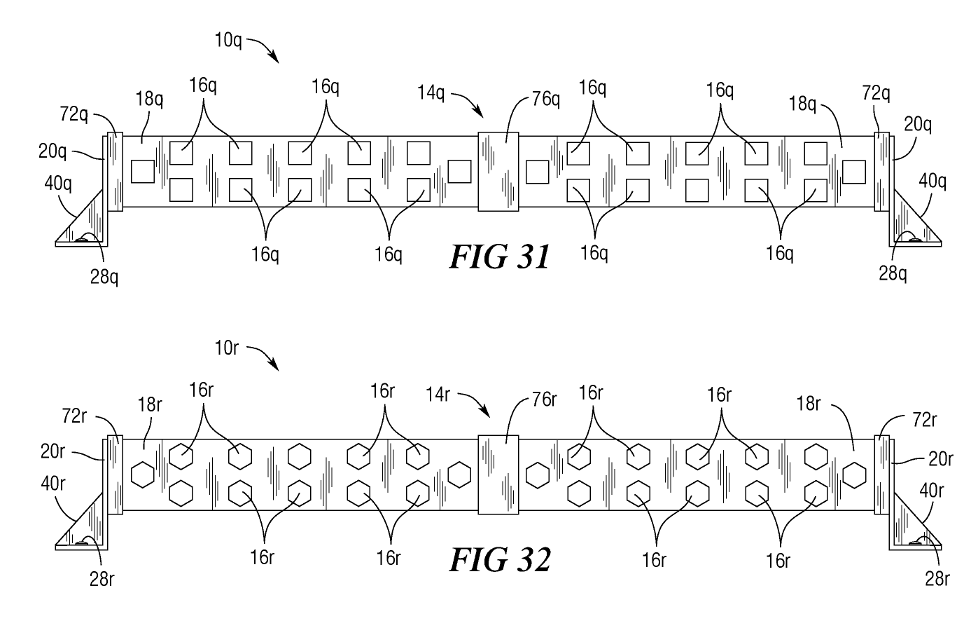

As shown in FIG. 29, the shape of each of the openings 16o of the organizing apparatus 10o are ovular. As shown in FIG. 30, the shape of each of openings 16p of the organizing apparatus 10p are trianglular. As shown in FIG. 31, the shape of each of the openings 16q of the organizing apparatus 10q are square. As shown in FIG. 32, the shape of each of the openings 16r of the organizing apparatus 10r are octogonal. In general, it should be understood that the shape of the openings 16 of the organizing apparatus 10 do not have to be uniform along the tube 14 and any combinations of shapes can be implemented.

This invention has been described with reference to several preferred embodiments. Many modifications and alterations will occur to others upon reading and understanding the preceding specification. It is intended that the invention be construed as including all such alterations and modifications in so far as they come within the scope of the appended claims or the equivalents of these claims.

1. An organizing apparatus for a plurality of utility straps, said organizing apparatus comprising:
a tube comprising a plurality of openings; and
said plurality of openings configured to allow the plurality of utility straps to releasably secure to said tube.

2. The organizing apparatus of claim 1 further comprising:
said tube configured to mount to a bracket; and
said bracket configured to allow said organizing apparatus to mount to a surface.

3. The organizing apparatus of claim 1 further comprising:
said tube configured to mount to a bracket, said tube configured to rotate when mounted to said bracket; and
said bracket comprising a hitch pin configured to stop said tube from rotating.

4. The organizing apparatus of claim 1 further comprising:
said tube comprising a plurality of tube lengths; and
a coupling configured to connect two of said plurality of tube lengths.

5. The organizing apparatus of claim 1 further comprising:
a cap located at each end of said tube;
each said cap configured to mount said tube to a bracket; and
each said cap configured to allow said tube to rotate when mounted to said bracket.

6. The organizing apparatus of claim 1 further comprising:
said tube comprising a plurality of tube lengths;
each said tube length comprising a male end and a female end; and
said male end of one said tube length configured to connect with said female end of another said tube length.

7. The organizing apparatus of claim 1 further comprising a handle releasably securable to said organizing apparatus.

8. The organizing apparatus of claim 1 further comprising a peg clip releasably securable to said organizing apparatus.

9. The organizing apparatus of claim 1 further comprising a crank securable to said organizing apparatus.

10. The organizing apparatus of claim 1 further comprising a bracket hook mountable to said organizing apparatus.

11. The organizing apparatus of claim 1 wherein the cross section of said tube is ovular, trianglular, circular, octogonal, or square.

12. The organizing apparatus of claim 1 wherein the shape of each of said plurality of openings is ovular, trianglular, circular, octogonal, or square.

13. The organizing apparatus of claim 1 wherein said tube is constructed from plastic, metal, vinyl, rubber, wood, glass, fiber glass, or a paper-based material.

14. An organizing apparatus for a plurality of utility straps, said organizing apparatus comprising:
a tube comprising a plurality of openings, said tube comprising a plurality of tube lengths, said tube configured to mount to a bracket;
the shape of each of said plurality of openings is ovular;
the cross section of said tube is square;
said plurality of openings configured to allow the plurality of utility straps to releasably secure to said tube;
each said tube length comprising a male end and a female end; and
said male end of one said tube length configured to connect with said female end of another said tube length.

15. The organizing apparatus of claim 14 further comprising a handle releasably securable to said organizing apparatus.

16. The organizing apparatus of claim 14 further comprising a peg clip releasably securable to said organizing apparatus.

17. The organizing apparatus of claim 14 further comprising a crank securable to said organizing apparatus.

18. The organizing apparatus of claim 14 further comprising a bracket hook mountable to said organizing apparatus.

19. The organizing apparatus of claim 14 wherein said bracket configured to allow said organizing apparatus to mount to a surface.

20. The organizing apparatus of claim 14 wherein said tube is constructed from plastic, metal, vinyl, rubber, wood, glass, fiber glass, or a paper-based material.

21. The organizing apparatus of claim 14 wherein said tube configured to rotate when mounted to said bracket.

22. The organizing apparatus of claim 14 wherein:
said tube configured to rotate when mounted to said bracket; and
said bracket comprising a hitch pin configured to stop said tube from rotating.

23. An organizing apparatus for a plurality of utility straps, said organizing apparatus comprising:
a tube comprising a plurality of openings;
the shape of each of said plurality of openings is ovular;
the cross section of said tube is square;
said plurality of openings configured to allow the plurality of utility straps to releasably secure to said tube;
a cap located at each end of said tube;
each said cap configured to mount said tube to a bracket; and
each said cap configured to allow said tube to rotate when mounted to said bracket.

24. The organizing apparatus of claim 23 further comprising:
said tube comprising a plurality of tube lengths; and
a coupling configured to connect two of said plurality of tube lengths.

25. The organizing apparatus of claim 23 further comprising a handle releasably securable to said organizing apparatus.

26. The organizing apparatus of claim 23 further comprising a peg clip releasably securable to said organizing apparatus.

27. The organizing apparatus of claim 23 further comprising a crank securable to said organizing apparatus.

28. The organizing apparatus of claim 23 further comprising a bracket hook mountable to said organizing apparatus.

29. The organizing apparatus of claim 23 wherein said tube is constructed from plastic, metal, vinyl, rubber, wood, glass, fiber glass, or a paper-based material.

30. The organizing apparatus of claim 23 wherein said bracket comprising a hitch pin configured to stop said tube from rotating.

31. The organizing apparatus of claim 23 wherein said bracket configured to allow said organizing apparatus to mount to a surface.
